(19) United States
(12) Patent Application Publication
(10) Pub. No.: US 2024/0320799 A1
(43) Pub. Date: Sep. 26, 2024

(54) INFORMATION PROCESSING APPARATUS, IMAGE PROCESSING APPARATUS, AND INFORMATION PROCESSING METHOD

(71) Applicant: CANON KABUSHIKI KAISHA, Tokyo (JP)

(72) Inventor: NAOKI KAKINUMA, Kanagawa (JP)

(21) Appl. No.: 18/602,325

(22) Filed: Mar. 12, 2024

(30) Foreign Application Priority Data
Mar. 20, 2023 (JP) 2023-044726

(51) Int. Cl. G06T 5/60; G06T 5/70

(52) U.S. Cl. CPC G06T 5/60; G06T 5/70; G06T 2207/10016; G06T 2207/20081; G06T 2207/20084

(57) ABSTRACT

An information processing apparatus that trains a machine learning model for reducing noise in a moving image is disclosed. The information processing apparatus performs a first training in which a first training dataset is applied to the machine learning model and a second training in which a second training dataset is applied to the machine learning model after the first training has ended. The trained machine learning model outputs an image as a processing result for a target frame for noise reduction from an input image consists of a plurality of frames including the target frame. The first training is to reduce noise, and the second training is to reduce degradation of image quality caused by variation between the plurality of frames.

### CROSS REFERENCE TO PRIORITY APPLICATION

This application claims the benefit of Japanese Patent Application No. 2023-044726, filed Mar. 20, 2023, which is hereby incorporated by reference herein in its entirety.

### BACKGROUND OF THE INVENTION

### Field of the Invention

The present invention relates to an information processing apparatus, an image processing apparatus, and an information processing method.

### Description of the Related Art

Image processing using machine learning (specifically, a trained neural network) is being widely used (Japanese Patent Laid-Open No. 2021-189857 (PTL)). In the PTL, the training accuracy is enhanced by training a neural network for image prediction in a specific order.

Specifically, in the PTL, using an object with easy-to-predict movement, the neural network is initially trained using moving images with a large amount of movement and then trained using moving images with a smaller amount of movement.

However, when a neural network for reducing noise is trained in a similar manner, image quality reduction may be caused by the effects of variation between frames.

### SUMMARY OF THE INVENTION

In consideration of the afore-mentioned problems with known techniques, some embodiments of the present invention provide an information processing apparatus and an information processing method for realizing a machine learning model that can reduce noise in moving images while reducing a degradation of image quality caused by variation between frames.

According to an aspect of the present invention, there is provided an information processing apparatus that trains a machine learning model for reducing noise in a moving image, the information processing apparatus comprising: one or more processors that execute one or more programs stored in a memory and thereby function as: a training unit configured to perform a first training in which a first training dataset is applied to the machine learning model and a second training in which a second training dataset is applied to the machine learning model after the first training has ended, wherein the machine learning model outputs an image as a processing result for a target frame for noise reduction from an input image consists of a plurality of frames including the target frame, and the first training is to reduce noise, and the second training is to reduce degradation of image quality caused by variation between the plurality of frames.

According to another aspect of the present invention, there is provided an image processing apparatus comprising: a machine learning model that outputs an image as a processing result for a target frame for noise reduction from an input image consists of a plurality of frames including the target frame, wherein the machine learning model has been trained through a first training in which a first training dataset is applied to the machine learning model and a second training in which a second training dataset is applied to the machine learning model after the first training has ended, and wherein the first training is to reduce noise, and the second training is to reduce degradation of image quality caused by variation between the plurality of frames; and one or more processors that execute one or more programs stored in a memory and thereby function as an obtaining unit configured to input a moving image to the machine learning model to obtain the moving image with reduced noise.

According to a further aspect of the present invention, there is provided an information processing method comprising: performing a first training in which a first training dataset is applied to a machine learning model for reducing noise in a moving image; and performing a second training in which a second training dataset is applied to the machine learning model after the first training has ended, wherein the machine learning model outputs an image as a processing result for a target frame for noise reduction from an input image consists of a plurality of frames including the target frame, and the first training is to reduce noise, and the second training is to reduce degradation of image quality caused by variation between the plurality of frames.

According to another aspect of the present invention, there is provided a non-transitory computer-readable medium storing a program for causing a computer to execute an information processing method comprising: performing a first training in which a first training dataset is applied to a machine learning model for reducing noise in a moving image; and performing a second training in which a second training dataset is applied to the machine learning model after the first training has ended, wherein the machine learning model outputs an image as a processing result for a target frame for noise reduction from an input image consists of a plurality of frames including the target frame, and the first training is to reduce noise, and the second training is to reduce degradation of image quality caused by variation between the plurality of frames.

Further features of the present invention will become apparent from the following description of exemplary embodiments (with reference to the attached drawings).

### BRIEF DESCRIPTION OF THE DRAWINGS

FIG. 1 is a block diagram illustrating an example of the hardware configuration of an information processing apparatus according to an embodiment.

FIG. 2 is a block diagram illustrating an example of the functional configuration of an information processing apparatus according to an embodiment.

FIG. 3 is a flowchart relating to an overview of a machine learning model training method according to an embodiment.

FIG. 4 is a detailed flowchart relating to a machine learning model training method according to an embodiment.

FIG. 5 is a diagram schematically illustrating the input and output of a machine learning model according to an embodiment.

FIG. 6 is a diagram relating to a method for generating a training dataset according to a first embodiment.

FIG. 7 is a diagram for comparing a first and second training according to the first embodiment.

FIG. 8 is a diagram relating to a training dataset according to a second embodiment.

### DESCRIPTION OF THE EMBODIMENTS

### First Embodiment

Exemplary embodiments of the present invention will be described below in detail with reference to the attached drawings. Note that the invention according to the scope of the claims are not limited by the embodiments described below. Also, a plurality of advantages of the embodiments are given, but all are not required for the invention. Also, the plurality of advantages may be combined in any manner. Furthermore, in the attached drawings, the same or equivalent components are denoted with the same reference number, and redundant descriptions will be omitted.

Note that in the embodiments described below, the present invention is described as being implemented as a computing device (personal computer, tablet computer, media player, PDA, or the like). However, the present invention can be implemented as any electronic device that uses a processor. Examples of such an electronic device include imaging apparatuses (digital cameras), smartphones, game consoles, robots, drones, and drive recorders. These are examples, and the present invention can be implemented as other electronic devices.

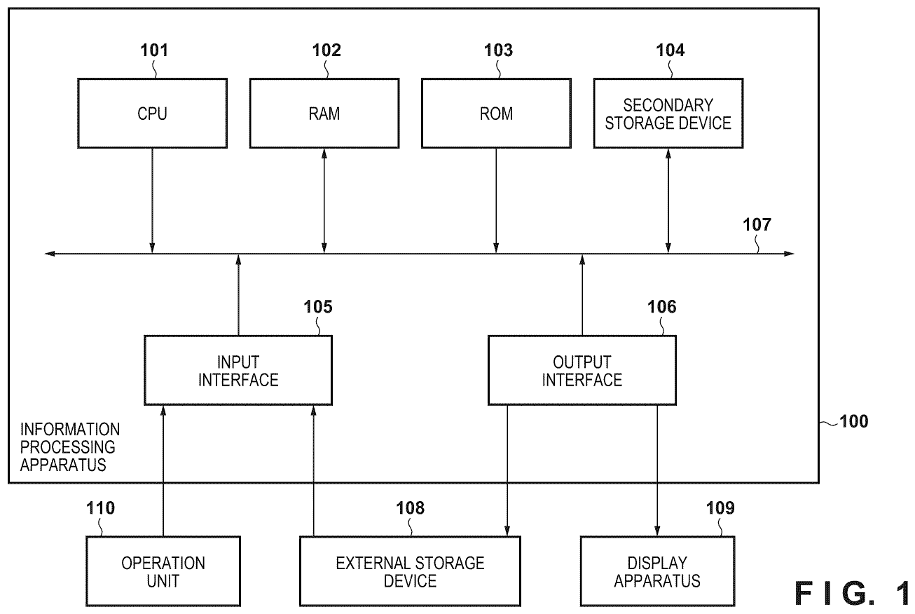

FIG. 1 is a block diagram illustrating an example of the hardware configuration of an information processing apparatus according to an embodiment. An information processing apparatus 100 includes a CPU 101, RAM 102, ROM 103, a secondary storage device 104, an input interface 105, and an output interface 106. The components of the information processing apparatus 100 are communicatively connected to one another via a system bus 107.

Also, the information processing apparatus 100 is connected to the external storage device 108 and an operation unit 110 via the input interface 105. The information processing apparatus 100 is also connected to the external storage device 108 and a display apparatus 109 via the output interface 106. Note that the operation unit 110, the external storage device 108, and the display apparatus 109 are described as external apparatuses, but they may be included in the information processing apparatus 100.

The CPU 101 uses the RAM 102 as working memory to execute programs (OS, applications, and the like) stored in the ROM 103 or the secondary storage device 104 and controls the operations of the components of the information processing apparatus 100 via the system bus 107. The operations of the information processing apparatus 100 described below are implemented by the CPU 101 executing the appropriate program for implementing the operation.

Note that one or more of the operations executed by the CPU 101 as described herein may be executed by the CPU 101 and another processor in cooperation instead of just by the CPU 101. The other processor may be a neural processing unit (NPU), a graphics processing unit (GPU), or the like configured to execute calculations relating to machine learning at high-speeds, for example. Programs executed by the other processor can also be stored in the ROM 103 or the secondary storage device 104.

The secondary storage device 104 stores programs executed by the CPU 101, user data, various data handled by the information processing apparatus 100, and the like. The secondary storage device 104 may be a storage device with a larger capacity than the ROM 103 such as an SSD, HDD, or the like. The CPU 101 accesses the secondary storage device 104 via the system bus 107.

The input interface 105 is a serial bus interface such as USB or the like. The information processing apparatus 100 can communicate with an external apparatus via the input interface 105. In the present embodiment, the operation unit 110 and the external storage device 108 are given as examples of external apparatuses that can connect to the input interface 105. However, other external apparatuses may also be connected. Also, the type and number of input interfaces 105 is not particularly limited.

The external storage device 108, for example, may be a storage device that uses a detachable storage medium such as a memory card, for example.

The operation unit 110 is an input device for the user of the information processing apparatus 100 to input instruction to the information processing apparatus 100 and may include one or more of a keyboard, a pointing device, a touchpad, a touch panel, a switch, a button, and the like.

Similar to the input interface 105, the output interface 106 is a serial bus interface such as USB, for example. Note that the output interface 106 may be a video output terminal such as digital visual interface (DVI), high-definition multimedia interface (HDMI) (registered trademark), or the like. The information processing apparatus 100 outputs data and the like to an external apparatus via the output interface 106. In the present embodiment, the display apparatus 109 and the external storage device 108 are given as examples of external apparatuses that can connect to the output interface 106. However, other external apparatuses may also be connected. Also, the type and number of output interfaces 106 is not particularly limited.

Note that the input interface 105 and the output interface 106 are separately described, but may actually be a single I/O interface. The input interface 105 and the output interface 106 may be one or more types of a wired or wireless communication interface that can connect to external devices.

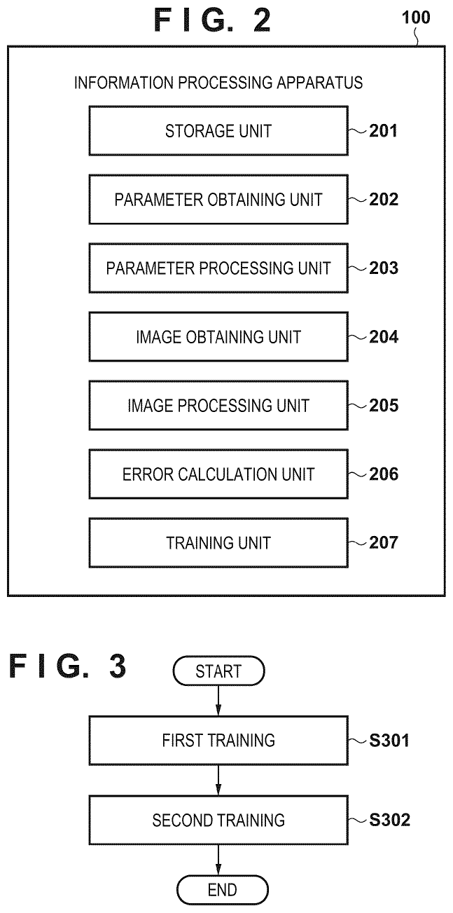

FIG. 2 is a block diagram illustrating an example of the functional configuration of the information processing apparatus 100. A storage unit 201 corresponds to the RAM 102, the ROM 103, the secondary storage device 104, and the external storage device 108. Also, other blocks 202 to 207 correspond to the functions implemented by the CPU 101 and/or another processor executing programs.

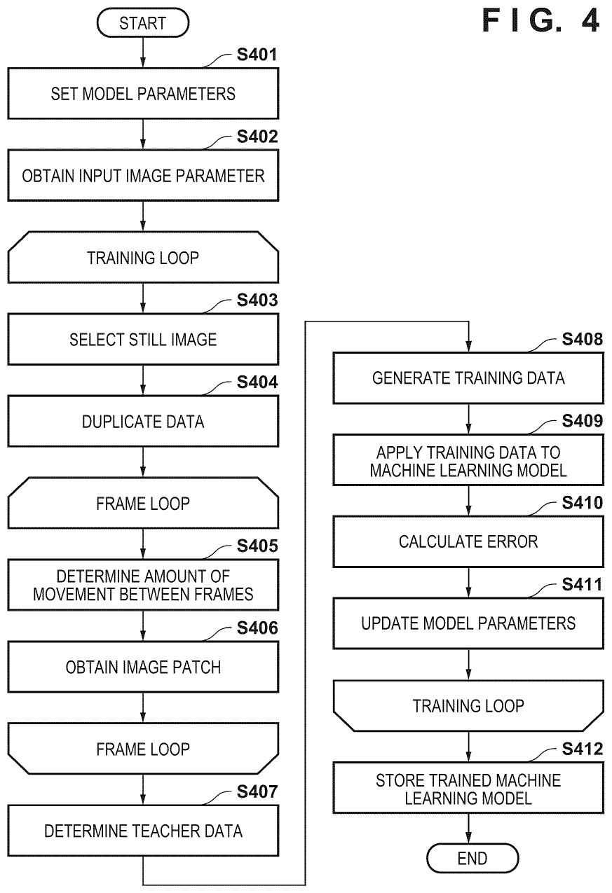

FIG. 3 is a flowchart illustrating, in a simplistic manner, the machine learning model training method used by the information processing apparatus 100 to reduce noise in moving images. In the present embodiment, training is performed in two stages.

To simplify the description and facilitate understanding, the training of a machine learning model using a convolutional neural network (CNN) is used in the following example. However, the machine learning model implementation method is not particularly limited. For example, a recurrent neural network (RNN), a transformer, or the like may be used. Note that the machine learning model targeted for training is encoded using an appropriate programming language and stored in advance in the secondary storage device 104, for example.

The machine learning model takes, from among a plurality of frames forming a moving image, a frame for noise reduction (target frame) and a predetermined number of preceding frames and subsequent frames of the target frame as input images and outputs an image of the target frame with reduced noise via inferencing using the input images. The configuration of the machine learning model (filter used in the convolution layer, activation function, loss function, and the like) are appropriately set according to the resolution of the input moving image or the like.

In step S301, the CPU 101 and/or another processor (hereinafter, simply referred to as the CPU 101) apply a first training to the machine learning model. The first training is to remove noise in the input image and enhance sharpness.

When the first training is complete, in step S302, the CPU 101 applies a second training to the machine learning model. The second training is to reduce degradation of image quality caused by variation between the frames of the input images and specifically to reduce the image lag that occurs around the moving object region caused by movement between frames.

By inputting the target frame and the frames before and after, compared to only inputting the target frame, variation in the processing of each frame relating to noise reduction and resolution enhancement can be reduced, allowing a stable processing result to be obtained. However, this gives rise to the need to reduce the image lag caused by movement between the frames being input. In the present embodiment, after training to reduce noise and enhance resolution is performed, training to reduce image lag is executed. Thus, the effect from inputting a plurality of frames can be sufficiently obtained.

As described below, the first training and the second training use different data sets in the training and have different initial learning rates. Note that for efficient training, the data sets used in training generate a plurality of images from the same still image by having different cropping positions. Noise is added to the plurality of images to generate artificial moving image frames that are used as machine learning model training data. At this time, one of the plurality of images is set as the noise reduction target frame and an image of the target frame before noise addition is set as teacher data (correct data). The target frame is handled as the frame located centrally in terms of time series from among the plurality of images.

Next, the machine learning model training method will be describes using the block diagram illustrated in FIG. 2 and the flowchart illustrated in FIG. 4. The first training and the second training have a common training method.

In step S401, a training unit 207 sets the parameters of the machine learning model. The parameters are weight parameters for the neural network and may also include a learning rate, a loss function, optimization settings (optimization algorithm), and the like.

In the present embodiment, in the first training, a weight parameter with an initial value set by random number generation. Also, in the second training, in step S412 described below, the weight parameter held in the storage unit 201 as the result of the first training is used.

Also, the initial learning rate of the second training is set to a value less than the initial learning rate of the first training. This is to prevent a weight parameter reflecting the first training from being greatly changed by the second training.

In step S402, a parameter obtaining unit 202 obtains a parameter relating to the input image data included in the training data input to the machine learning model. The parameter relating to the input image data is, for example, the input image data frame number, the amount of movement between frames, or the like.

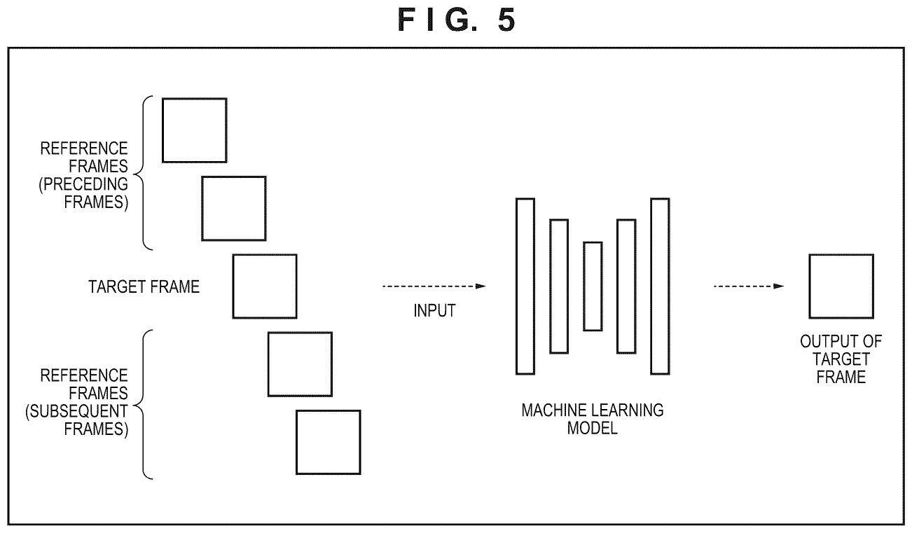

In the present embodiment, the frame number that is simultaneously input to the machine learning model is an odd number equal to or greater than 3. In this example, 5 is used as illustrated in FIG. 5. Then, the frame located centrally in terms of time series is set as the target frame, and the other frames are set as reference frames. The machine learning model takes the target frame and the reference frames as input images and outputs an image of the target frame with reduced noise via inferencing.

Also, in the present embodiment, the amount of movement between frames is the maximum value in the horizontal direction and the vertical direction of the amount of movement between adjacent frames on the basis of the plurality of frames used as input images. The amount of movement between frames is a parameter used to reduce the image lag that occurs around the moving object region in a frame.

When training is performed using a data set with a large amount of movement between frames, the effect of reducing the image lag that occurs around the moving object region can be increased, but the sharpness of the image is decreased. On the other hand, when training is performed using a data set with a small amount of movement between frames, the effect of reducing noise while enhancing the sharpness of the image is obtained, but image lag tends to occur around the moving object region.

Thus, the first training uses a data set with a small amount of movement between frames, and the second training uses a data set with a larger amount of movement between frames than the first training. Also, by the initial learning rate of the second training being less than the initial learning rate of the first training, the effect on the result of the first training by the second training is reduced.

By applying two-stage training in this manner, the effect (second training result) of reducing the image lag that occurs around the moving object can be provided to the weight parameter (first training result) for implementing noise reduction and sharpness enhancement.

The amount of movement between frames for the data set used in the first training may be the amount of movement in both the horizontal direction and the vertical direction caused by typical handshake that occurs when a moving image is captured via hand-held imaging, for example. It is also dependent on the pixel pitch of the image sensor, but for example, it may be 10 pixels in both the horizontal direction and the vertical direction.

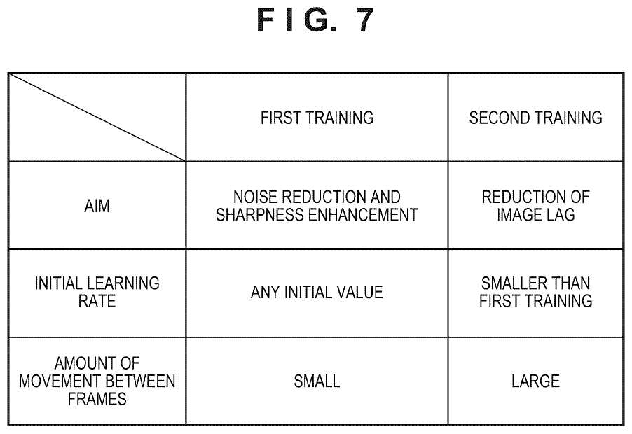

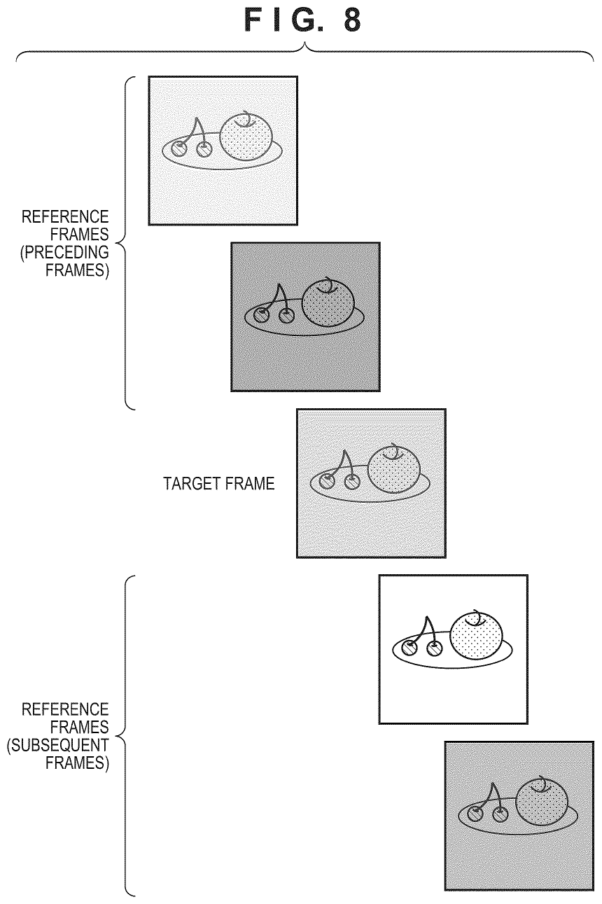

The amount of movement between frames in the data set used in the second training is a value (a value greater than 20 pixels and in this example, 30 pixels) in both the horizontal direction and the vertical direction greater than the amount of movement between frames of the data set used in the first training. The specific amount of movement between frames may be empirically obtained, but the amount of movement between frames suitable for training to reduce the image lag of the moving object region corresponds to a value greater than the amount of movement between frames suitable for training to reduce noise and enhance sharpness. FIG. 7 illustrates an overview of the first training and the second training.

In step S403, an image obtaining unit 204 randomly selects one piece of still image data from the plurality held by the storage unit 201. The still image data is data that is captured under imaging conditions (for example, 100 ISO sensitivity) for obtaining an image with minimal noise.

In step S404, the parameter obtaining unit 202 duplicates the still image data selected in step S403 to realize the frame number obtained in step S402 and stores this in the storage unit 201.

In step S405, a parameter processing unit 203 decides the amount of movement in the horizontal direction and the vertical direction to be applied to the pieces of still image data stored in step S404. Here, the parameter processing unit 203 sets the amount of movement in both the horizontal direction and the vertical direction to 0 for the still image data used as the target frame.

Also, for the pieces of still image data used as reference frames, for example, the parameter processing unit 203 randomly sets the amount of movement in the horizontal direction and the vertical direction in a range of the amount of movement between frames according to whether the training dataset to be generated is for the first training or the second training. Specifically, if the amount of movement between frames is X, the parameter processing unit 203 sets an amount of movement nx in the horizontal direction and an amount of movement ny in the vertical direction within the range −X≤nx≤X and −X≤ny≤X. Note that the amount of movement is a pixel-unit integer.

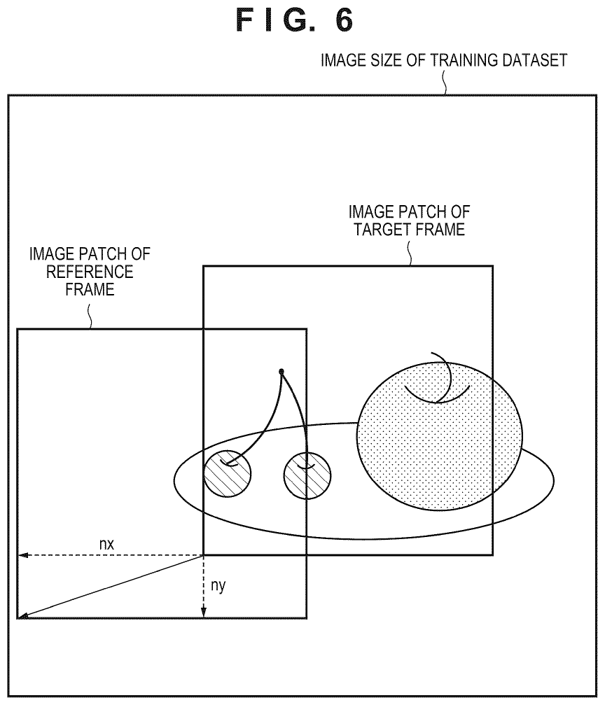

In step S406, the image obtaining unit 204 crops the image data (image patch) to a predetermined size from the pieces of still image data on the basis of the amount of movement decided in step S405. FIG. 6 is a diagram schematically illustrating the image patch obtaining operations in step S406. By using the cropping position of the image patch used as the target frame to move the cropping position an amount of movement equal to the amount of movement decided in step S405, an image patch used as a reference frame is obtained. The image obtaining unit 204 stores the generated image patch (target frame and reference frame) in the storage unit 201.

Note that the cropping position of the image patch used as the target frame is set to at or near the center of the still image before cropping. The cropping position used as a reference may be set so that the center of the image and the center of the image patch match, may be set to include a feature area (for example, a face region, a human body region, or the like) included in the still image before cropping or a main subject region, or another method may be used. Feature areas and main subject regions can be detected and decided via a known method.

In this manner, an image patch generated from the same still image with its cropping position changed is used in training the machine learning model as an artificial moving image frame.

In step S407, the image obtaining unit 204 stores the image patch used as the target frame as teacher data in the storage unit 201.

In step S408, an image processing unit 205 applies a predetermined image processing to each of the image patches generated in step S406 to generate training data. A combination of training data and corresponding teacher data is a data unit constructing the training dataset.

In the present embodiment, noise reduction is one of the aims of the first training. However, since little noise is included in the still image data corresponding to the source of the training data, image processing for artificially adding brightness noise that occurs when imaging at high sensitivity can be applied. In a case where the imaging sensitivity of the moving image to be applied to the machine learning model after training is known in advance, the image processing unit 205 can apply image processing for simulating the noise that occurs at the imaging sensitivity to the training data. Also, image processing for reducing the image size for reducing the training load can also be applied in step S408.

In step S409, the training unit 207 applies the training data generated in step S408 to the machine learning model and obtains image data from the machine learning model.

In step S410, an error calculation unit 206 calculates the error between the image data obtained from the machine learning model in step S409 and the teacher data stored in the storage unit 201 in step S407. The error can be calculated using a known loss function such as the absolute value sum of the differences of the corresponding pixel values of the image data.

In step S411, the training unit 207 updates the parameters of the machine learning model to minimize the error calculated in step S410. Specifically, the training unit 207 can update the parameters via the backpropagation method, for example. Note that in the present embodiment, training ends when the number of times training has been performed is equal to or greater than a predetermined number of times and the calculated error is equal to or less than a predetermined value.

In step S412, the training unit 207 stores the parameters of the machine learning model at the end of training in the storage unit 201.

In a case where the first training has been executed, the parameters of the machine learning model at the end of training are used in the model parameters setting of step S401 when executing the second training. Also, the parameters of the machine learning model at the end of the second training are used when applying the test data to the machine learning model.

According to the present embodiment, the executed training of the machine learning model for reducing noise in the moving image is divided into the first training for noise reduction and sharpness enhancement and the second training for reducing the image lag that occurs around the moving object region. Accordingly, training using a training dataset appropriate for each aim can be performed, and noise reduction and resolution enhancement can be achieved while reducing occurrences of image lag caused by movement between frames.

Note that the training dataset is generated by changing the cropping position of the same still image, but another method may be used. For example, the training dataset may be generated by extracting images corresponding to the amount of movement between frames from still images captured via continuous shooting while panning, from still images captured via continuous shooting of a scene including the moving object, from frame images extracted from moving images, or the like. In these cases, also, the operations (operations after step S407) after the training dataset is generated may be as described above.

Also, the number of reference frames before and after the target frame may not be equal. In this case, the frame number of the training data may not be an odd number.

Also, the amount of movement relative to the reference position of the cropping position is randomly decided in a range of the amount of movement between frames, but to simulate movement of an object, the amount of movement between frames may be restricted to a predetermined direction, for example. Also, the movement between frames may include scaling and/or rotation in addition to movement in the horizontal and vertical directions.

### Second Embodiment

The second embodiment of the present invention will be described below. In the present embodiment also, the information processing apparatus 100 described using FIGS. 1 and 2 can be implemented. Thus, configurations shared with the first embodiment will not be described.

In the present embodiment, the second training is to reduce degradation of image quality caused by a change between frames and is specifically to reduce color unevenness caused by a change in brightness between frames. The target change in brightness here is mainly caused by a flickering light source (fluorescent lamp, LED, or the like) included in environment light. A flickering light source periodically changes in brightness. Thus, a moving image captured under a flickering light source may have variation in brightness between frames. A change in brightness between frames that form the input image of the machine learning model, in particular, between the target frame and the reference frame, may cause color unevenness in the output image of the machine learning model.

The processes for performing operations that differ from the first embodiment will be focused on in the following description using the flowchart in FIG. 4.

In step S402, the parameter obtaining unit 202 obtains a parameter relating to the input image data included in the training data input to the machine learning model. The parameter relating to the input image data is, for example, the input image data frame number, the brightness variation rate between frames, or the like. The brightness variation rate between frames is the maximum value of the ratio of the difference in average brightness values between the target frame and the reference frame, for example.

The first training is to enhance sharpness and time direction stability. Thus, the brightness variation rate between frames is set to a value greater than 0 but sufficiently small. For example, in the present embodiment, the brightness variation rate is set to 2%.

The second training is to reduce the adverse effects caused by brightness variation between frames. Thus, the brightness variation rate between frames is greater than that of the first training. For example, in the present embodiment, it is set to 20%.

In step S405, the parameter processing unit 203 decides the brightness variation rate to be applied to the pieces of still image data stored in step S404. Here, the parameter processing unit 203 sets the brightness variation rate to 0% for the still image data used as the target frame.

Also, for the pieces of still image data used as reference frames, for example, the parameter processing unit 203 randomly sets the brightness variation rate in a range of the brightness variation rate between frames according to whether the training dataset to be generated is for the first training or the second training. Specifically, if the brightness variation rate between frames is Y %, the parameter processing unit 203 sets a brightness variation rate m for each piece of still image data within the range −Y≤m≤Y.

In step S406, the image obtaining unit 204 crops the image data (image patch) to a predetermined size from the pieces of still image data. Here, the cropping position is a fixed position. In the case of a fixed cropping position, instead of the duplication processing in step S404, the image patch cropped in step S406 may be duplicated. The image obtaining unit 204 stores the generated image patch (target frame and reference frame) in the storage unit 201.

In step S407, the image obtaining unit 204 stores the image patch used as the target frame as teacher data in the storage unit 201.

In step S408, for the image patch of the reference frame from among the image patches generated in step S406, the image processing unit 205 applies the variation rate set in step S405 to the pixel values (brightness values) and generates training data. Also, the image processing unit 205 applies image processing to add noise as in the first embodiment to each image patch of the target frame and the reference frame.

Note that the cropping position is fixed in step S406, but the cropping position may be changed. In this case, since the images in the pixel patches do not match, in step S408, the image processing unit 205 applies image processing to change the pixel values so that the average brightness value of the pixel patches satisfies the brightness variation rate set in step S405.

According to the present embodiment, the executed training of the machine learning model for reducing noise in the moving image is divided into the first training for noise reduction and sharpness enhancement and the second training for reducing the effects caused by brightness variation between frames. Accordingly, training using a training dataset appropriate for each aim can be performed, and noise reduction and resolution enhancement can be achieved while reducing the effects caused by brightness changes between frames caused by a flickering light source, for example.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus that trains a machine learning model for reducing noise in a moving image, the information processing apparatus comprising:
one or more processors that execute one or more programs stored in a memory and thereby function as:
a training unit configured to perform a first training in which a first training dataset is applied to the machine learning model and a second training in which a second training dataset is applied to the machine learning model after the first training has ended,
wherein the machine learning model outputs an image as a processing result for a target frame for noise reduction from an input image consists of a plurality of frames including the target frame, and
the first training is to reduce noise, and the second training is to reduce degradation of image quality caused by variation between the plurality of frames.

2. The information processing apparatus according to claim 1, wherein an initial learning rate of the second training is lower than an initial learning rate of the first training.

3. The information processing apparatus according to claim 1, wherein the second training is to reduce image lag caused by movement between the plurality of frames.

4. The information processing apparatus according to claim 3, wherein the one or more processors further function as a generating unit configured to generate, based on still images, the first training dataset and the second training dataset.

5. The information processing apparatus according to claim 3, wherein the one or more processors further function as a generating unit configured to generate the first training dataset and the second training dataset, and
the generating unit generates the first training dataset and the second training dataset so that a maximum value of an amount of movement between frames that are used as the input image in the second training to be greater than a maximum value of an amount of movement between frames that are used as the input image in the first training.

6. The information processing apparatus according to claim 1, wherein the second training is to reduce an effect caused by a change in brightness between the plurality of frames.

7. The information processing apparatus according to claim 6, wherein the one or more processors further function as a generating unit configured to generate the first training dataset and the second training dataset, and
the generating unit generates the first training dataset and the second training dataset so that a brightness variation rate between frames that are used as the input image in the second training to be greater than a brightness variation rate between frames that are used as the input image in the first training.

8. The information processing apparatus according to claim 1, wherein the machine learning model uses a neural network.

9. An image processing apparatus comprising:
a machine learning model that outputs an image as a processing result for a target frame for noise reduction from an input image consists of a plurality of frames including the target frame, wherein the machine learning model has been trained through a first training in which a first training dataset is applied to the machine learning model and a second training in which a second training dataset is applied to the machine learning model after the first training has ended, and wherein the first training is to reduce noise, and the second training is to reduce degradation of image quality caused by variation between the plurality of frames; and
one or more processors that execute one or more programs stored in a memory and thereby function as an obtaining unit configured to input a moving image to the machine learning model to obtain the moving image with reduced noise.

10. An information processing method comprising:
performing a first training in which a first training dataset is applied to a machine learning model for reducing noise in a moving image; and
performing a second training in which a second training dataset is applied to the machine learning model after the first training has ended,
wherein the machine learning model outputs an image as a processing result for a target frame for noise reduction from an input image consists of a plurality of frames including the target frame, and
the first training is to reduce noise, and the second training is to reduce degradation of image quality caused by variation between the plurality of frames.

11. A non-transitory computer-readable medium storing a program for causing a computer to execute an information processing method comprising:
performing a first training in which a first training dataset is applied to a machine learning model for reducing noise in a moving image; and
performing a second training in which a second training dataset is applied to the machine learning model after the first training has ended,
wherein the machine learning model outputs an image as a processing result for a target frame for noise reduction from an input image consists of a plurality of frames including the target frame, and
the first training is to reduce noise, and the second training is to reduce degradation of image quality caused by variation between the plurality of frames.
